(19) United States
(12) Patent Application Publication
(10) Pub. No.: US 2004/0243649 A1
(43) Pub. Date: Dec. 2, 2004

(54) Method for sync-ahead on a dual mode high-power-low-power device and apparatus therefore

(76) Inventors: Dirk Husemann, Adliswil (CH); Michael Moser, Zurich (CH)

Correspondence Address: Louis J Percello, IBM Corporation, P O Box 218, Yorktown Heights, NY, 10598, US

(21) Appl. No.: 10/489,835

(22) PCT Filed: Sep. 13, 2002
(86) PCT No.: PCT/EP02/10287

(30) Foreign Application Priority Data
Sep. 29, 2001 (EP) 01123522.3

(51) Int. Cl. G06F 17/30

(52) U.S. Cl. 707/201

(57) ABSTRACT

A notebook computer contains in addition to the normal motherboard an additional self-contained low-power unit, such as an embedded PDA. With such a notebook computer there are two modes of operation possible, a high-power mode and a low-power mode. In order to make use of the embedded PDA, files, such as word processor documents, presentations and so forth are made available to the PDA. In accordance with the present invention this is done by establishing a set of working files. This may be done based on their modification date and it may depends on the requirements of the user as well as on the available resources of the embedded PDA.

### BACKGROUND OF THE INVENTION

1. Field of the Invention

The present invention generally relates to data processing devices, such as portable, notebook or laptop computers and personal digital assistants that include techniques for minimizing energy consumption. Particularly, the present invention relates to a method and system for synchronizing data between such devices. More particularly, the present invention relates to a method for synchronizing data between a first data storage device associated to a first data processing unit and a second data storage device associated to a second data processing unit, whereby said first and said second data processing unit are arranged in a common housing and said second data processing unit is configured to consume less energy than said first data processing unit, and a respective data processing apparatus.

2. Description of the Related Art

Portable computers can only function for several hours before draining their battery sources. Some of the major power using components are the mass storage devices like a hard disk drive, an optical disk drive, such as a CD-ROM (Compact Disk Read Only Memory) drive, and the microprocessor or central processing unit (CPU). The primary power management technique for the components in portable computers is the use of several reduced-power or power-save operating modes, each mode being entered following the time-out of a fixed predetermined time period since the component was last accessed. The computer may have a reduced-power operating mode which turns the hard disk off, one which reduces overall system power but leaves the system in an intermediate state of readiness (e.g., STANDBY), and one which turns off most of the components and requires a special process to return to the active state (e.g., SUSPEND).

Additionally, the computer may be able to control the power modes of some of the individual components. There may be reduced clock rate mode for the CPU, and reduced-power modes for the peripheral components, such as the CD-ROM and hard disk drive. For example, at the end of a fixed time period since the user last read data from the CD-ROM, the read head is moved to its parking location and the CD-ROM spindle motor is shut off. When the user next accesses the CD-ROM, the spindle motor is spun up and the head is moved across the disk to read data on the appropriate data track. The primary disadvantage of such a power-save mode is the time delay in exiting the mode, during which the user must wait. This greatly affects the performance of the computer.

A further disadvantage is the potential of increasing energy usage by entering a power-save mode inappropriately. Typically, the lengths of the fixed time periods are set by the computer user through software.

In order to provide an energy-saving computer system that may be used with less drawbacks in view of usability, the U.S. Pat. No. 5,954,820 by Steven Robert Hetzler, assigned to International Business Machines Corporation, Armonk, N.Y. (US), filed 26 Sep. 1997, issued 21 Sep. 1999, “Portable computer with adaptive demand-driven power management” suggests a method for managing power in a portable computer which uses past access history of the various electrically-powered computer components and a prediction of future user demands to determine power-save mode entry and exit conditions. The component or the computer system keeps track of the access patterns. In the case of the display system component, such as the LCD display panel, because the access occurs when the user is watching the display panel and is thus not possible to measure directly, the accesses are measured indirectly from keyboard and/or pointing device activity. Each component access is detected and used to compute a current access frequency. The current access frequency is compared to a previously calculated and continuously updated threshold frequency. The threshold frequency is representative of the access pattern, e.g., uniform or sporadic, and is computed from equations that include adjustable gain factors. During operation of the component the appropriate power-save mode is entered when the current access frequency falls below the threshold frequency. The component can also adapt dynamically to varying workload situations, thereby saving more energy without degrading performance. This is accomplished by adjusting the gain factors parameters in response to tracking the actual performance of the system, thereby changing the threshold frequency. The component also determines when to exit a power-save mode without necessarily waiting for a user access.

A different approach for providing data processing capability independently from line voltage supply is to use a palmtop computer or a personal digital assistant (PDA) instead of a portable, laptop or notebook computer. Palmtop computers and PDAs are configured to consume significantly less energy than other computers. This is mainly because they omit hard disk drives and other mass storage devices constantly consuming energy. Furthermore, the CPUs (Central Processing Units) used in such devices are particularly designed for a low power scenario. However, instead of having trouble in deciding what power mode to switch to, here, the issue arises which data to transfer from the high power device, i.e., portable, laptop or notebook computer, to the low power device, i.e., the palmtop or PDA.

U.S. Pat. No. 5,666,530 by Ted H. Clark et. al., assigned to Compaq Computer Corporation, Houston, Tex. (US), filed 2 Dec. 1992, issued 9 Sep. 1997, “System for automatic synchronization of common file between portable computer and host computer via communication channel selected from a plurality of usable channels there between” discloses a handheld computer which contains an LCD (Liquid Crystal Display) display having a digitizing surface to allow pen input. Internal storage takes several forms, such as a large flash ROM (Read Only Memory) area, battery-backed up RAM (Random Access Memory) and an optional hard disk drive. Several alternative communication paths are available, such as the previously mentioned modem, a parallel printer port, a conventional serial port, a cradle assembly connected to the host computer, and various wireless short distance techniques such as radio frequency or infrared transmission. The computer can readily communicate with other sources, particularly to a host desktop computer, to allow automated synchronization of information between the host and the handheld system. Preferably the remote synchronization is performed at several user selectable levels. When the handheld computer is in a cradle and actively connected to the host computer, automatic capture of updated data in the host computer is performed. Several synchronization techniques are utilized to keep track of different types of files. In addition, while communication is established the handheld computer can enter a remote control mode, allowing the user access to files and applications not included in the handheld computer.

Although the user is slightly unburdened from taking care of the data being needed to be carried within the handheld computer, the user now has to consider when to take what device.

### OBJECT OF THE INVENTION

Starting from this, the object of the present invention is to provide a method and an apparatus that improves the usage of a low power device.

### BRIEF SUMMARY OF THE INVENTION

The foregoing object is achieved by a method and a system as laid out in the independent claims. Further advantageous embodiments of the present invention are described in the sub claims and are taught in the following description.

A data processing apparatus, such as a PC (Personal Computer), a notebook or a laptop computer, in the following referred to as notebook computer, contain in addition to the normal motherboard a self-contained low-power unit, such as an embedded PDA, in the following referred to as embedded PDA. The motherboard refers to the main printed circuit board of a computer including a bus, a microprocessor, and integrated circuits used for controlling any built-in peripherals such as the keyboard, text and graphics display, serial ports and parallel ports, joystick, and mouse interfaces, whereas a PDA refers to a small computer providing slightly less functionality as the notebook computer, but consuming significantly less energy.

With such a notebook computer there are two modes of operation possible. First, a high-power mode in which the notebook is being used as it is currently done. Namely, in the high-power mode it is possible to access power-intensive parts of the notebook, such as a modem, a hard disk or a CD/DVD (Compact Disk/Digital Versatile Disc) drive, and perform power expensive calculations needing a high processor clock rate. Second, a low-power mode in which the main part of the notebook is suspended and the embedded PDA is running.

The embedded PDA can for example be a device running Windows CE operating system by Microsoft Corporation, Palm OS by Palm Inc. or embedded Linux. The PDA and the motherboard are interconnected and are configured to share certain parts of the hardware, such as a keyboard, serial ports and a display. In order to make use of the embedded PDA, files, such as word processor documents, presentations and so forth are made available to the PDA. They may even be transformed into a format that is suitable for the applications running on the PDA. The present invention proposes several different methods of automating the procedure of making data available from the notebook computer to the embedded PDA to increase ease of use of these devices. Hence, the user is advantageously freed of manually copying or synchronizing user-specified files from the high-power part to the low-power PDA and vice versa. In other words, the data gets synchronized between a first data storage device, such as the hard disk, associated to a first data processing unit, i.e., the notebook computer, and a second data storage device, such as a flash memory, associated to a second data processing unit, i.e., the PDA.

In accordance with the present invention a set of working files is established, i.e., files that were “recently” used are identified and prepared for copying from the notebook computer to the embedded PDA or vice versa. This may be done based on their modification date. However, the definition of “recently” is a configurable parameter and depends not only on the requirements of the user, but may also take into account the available resources of the embedded PDA. According to a first embodiment the files of the working file set are transformed, if necessary, and synchronized with the PDA.

In a second embodiment of the present invention a filter mechanism is introduced. Instead of synchronizing every changed file in the working file set, the user can provide a filter to synchronize a specific subset of the working file set, e.g., the user can provide a filter to synchronize only Lotus Freelance Presentation files to the PDA module. The filter process can, for example, be controlled through regular expressions or simpler expressions such as the Unix shell globbing expressions.

Furthermore, in a third embodiment of the present invention the user is enabled to manually earmark certain files and indicate to a transformation and synchronization process that those files should be synchronized in any case. The transformation and synchronization process is always present on the embedded PDA module in order to supervise the respective transformation and synchronization of the selected files. The earmarking can be implemented table based, by using symbolic links, a database, or special flags in the file system directory.

In the embodiments described above the transformation and synchronization process may be triggered by a time-out signal of a timer. Thus, the transformation and synchronization process may be performed periodically.

In a fourth embodiment of the present invention the set of working files are extracted differently. Instead of periodically checking the modification dates of files present in the file system of the high-power part of the system, operating system calls of the running applications are traced. This may be done by tracing the file system open calls which allows a very precise notion of the files that are being worked on. Furthermore, by tracing the exit calls it becomes apparent when an application has stopped working with the files that were identified by tracing the file system open calls. At this point in time the files the application has worked with can safely be transformed and synchronized without the risk of interference.

The tracing can either be done through hooks, e.g., an application intercepting operating system calls through a debugger interface, as an integrated feature of the operating system, or by instrumenting just certain applications.

Typically, an application communicates with an operating system through system calls, e.g., requesting some service to be rendered by the operating system. However, most modern operating system support the concept of shared libraries, i.e., library code that is shared among several applications running on the same host, thereby reducing the amount of memory required. An added advantage of shared library code is that one can enhance and update this kind of code without having to change the applications that use a shared library. Thus, instead of instrumenting the application code directly the code of the shared libraries may be adapted and thereby added the tracing capability to all application that use the modified shared libraries. Furthermore, with some operating systems, such as Linux, a special shared library may be added to the set of shared libraries used by a particular application. Hence, the tracing capabilities are enabled without the need of modifying any shared library.

According to a fifth embodiment of the present invention the transformation and synchronization process is triggered whenever the system is switched from high-power to low-power mode. At this time, the set of working files that were extracted using any of the previous methods are transformed and synchronized in a batch processing. The advantage of this extension is that any user- and application-initiated system activity is suspended and, hence, file integrity is guaranteed.

### BRIEF DESCRIPTION OF THE SEVERAL VIEWS OF THE DRAWINGS

The above, as well as additional objectives, features and advantages of the present invention, will be apparent in the following detailed written description.

The novel features of the invention are set forth in the appended claims. The invention itself, however, as well as a preferred mode of use, further objectives, and advantages thereof, will best be understood by reference to the following detailed description of an illustrative embodiment when read in conjunction with the accompanying drawings, wherein:

FIG. 1 shows a block diagram of an apparatus in accordance with the present invention comprising a motherboard with self-contained low-power unit, sharing video, keyboard and serial components;

FIG. 2 shows a block diagram illustrating interaction between an application and an operating system through system calls in accordance with the present invention;

FIG. 3 shows a block diagram illustrating tracing open/close/exit system calls by intercepting system calls in the operating system itself in accordance with the present invention.

FIG. 4 shows a block diagram illustrating tracing open/close/exit system calls by a specially prepared application in accordance with the present invention; and

FIG. 5 shows a block diagram illustrating tracing open/close/exit system calls through a modified shared library in accordance with the present invention.

### DETAILED DESCRIPTION OF THE INVENTION

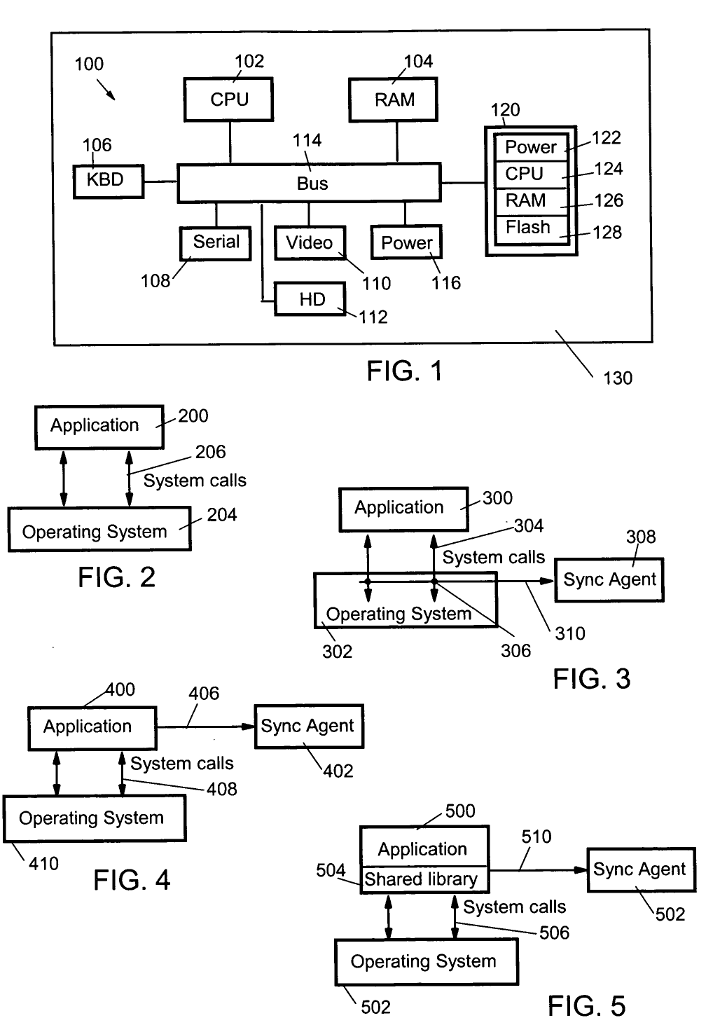

With reference now to FIG. 1, there is depicted a block diagram of an apparatus in accordance with the present invention comprising a motherboard with self-contained low-power unit, sharing video, keyboard and serial components. The main PC system 100 includes a CPU 102, RAM 104, and I/O peripherals, such as a keyboard 106, a serial port 108, a video display adapter 110, and a hard disk adapter or drive 112. All those components are connected through one or more bus systems 114 and some power supply 116. Attached to the bus 114 is an independent low-power subsystem 120 containing an independent power source 122, such as a rechargeable battery not shown, an independent low-power CPU 124, an independent RAM memory 126, and some nonvolatile, long-term memory 128, such as flash memory. The low-power subsystem 120 can operate independently of the main PC system 100 but has access through the system buses 107 to some I/O peripherals located on the main motherboard. Both the main PC system 100 and the low-power subsystem 120 are arranged in a common housing 130.

FIG. 2 shows a block diagram illustrating interaction between an application 200 and an operating system 204 through system calls 206 in accordance with the present invention. The procedure of doing an operating system call is well documented in literature, for example: Maurice J. Bach, “The Design of the Unix Operating System”; or Andrew S. Tanenbaum, “Modern Operating Systems.” Basically a system call is a piece of (assembler) code that calls a special trap instruction, resulting in an interrupt that is then serviced by the operating system kernel depending on parameters passed in from the application where the syscall originated.

Now with reference to FIG. 3, there is depicted a block diagram illustrating tracing open/close/exit system calls by intercepting system calls in the operating system itself in accordance with the present invention. An application 300 interacts with the operating system 302 through system calls 304. Those system calls 304 are traced through a tracing interface 306 provided by the operating system 302. Extracted tracing information is forwarded to the synchronization agent 308 as indicated by arrow 310. Either the synchronization agent 308 or already the operating system tracing interface 306 filter out non-file system related system calls. The synchronization agent 308 however analyzes all file system related system calls initiated by the application 300 and determines the active file working set to be synchronized.

FIG. 4 shows a block diagram illustrating tracing open/close/exit system calls by a specially prepared application in accordance with the present invention. An application 400 has been instrumented with special instructions that tell a synchronization agent 402 which files it is currently using. This information is forwarded via a communication channel to the synchronization agent 404 as indicated by arrow 406. System calls 408 from the application 400 to the operating system 410 may be performed unchanged.

With reference now to FIG. 5, there is shown a block diagram illustrating tracing open/close/exit system calls through a modified shared library in accordance with the present invention. An application 500 interacts with the operating system 502 through shared libraries 504. The shared libraries 504 themselves interact with the operating system 502 via system calls 506. By either modifying existing shared libraries or by added additional shared libraries to the load set new functionality is added which enhance the application 500 without having to modify the application 500 itself. Thus, file set tracing functionality is added and the trace information is delivered to the synchronization agent 508 as illustrated by arrow 510.

The present invention can be realized in hardware, software, or a combination of hardware and software. Any kind of computer system—or other apparatus adapted for carrying out the methods described herein—is suited. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which—when loaded in a computer system—is able to carry out these methods.

Computer program means or computer program in the present context mean any expression, in any language, code or notation, of a set of instructions intended to cause a system having an information processing capability to perform a particular function either directly or after either or both of the following a) conversion to another language, code or notation; b) reproduction in a different material form.

1. A method for synchronizing data between a first data storage device (112) associated to a first data processing unit (100) and a second data storage device (128) associated to a second data processing unit (120), whereby said first and said second data processing unit (100, 120) are arranged in a common housing (130) and said second data processing unit (120) is configured to consume less energy than said first data processing unit (100), the method comprising the following steps:
selecting data files stored on said first data storage device (112),
copying the selected data files from said first data storage device (112) to said second data storage device (128).

2. The method according to claim 1, wherein the step of selecting data files stored on said first data storage device (112) comprises the step of:
applying filtering rules in order to single out files to be copied.

3. The method according to claim 2, wherein said filtering rules include regular expressions.

4. The method according to one of the claims 1 to 3, wherein the step of selecting data files stored on said first data storage device (112) comprises the step of:
choosing files being marked by a user of said first and second data processing unit (100, 120) as to be copied.

5. The method according to claim 4, wherein the files are being marked by using symbolic links, database entries and/or flags associated to respective files.

6. The method according to one of the preceding claims, wherein the step of selecting data files stored on said first data storage device (112) comprises the step of:
checking the available resources on the second data processing unit (120) and, in consideration of the result, selecting data files stored on said first data storage device (112).

7. The method according to one of the preceding claims, wherein the steps of selecting data files stored on said first data storage device (112) and copying the selected data files from said first data storage device (112) to said second data storage device (128) are performed periodically.

8. The method according to one of the claims 1 to 6, wherein the steps of selecting data files stored on said first data storage device (112) and copying the selected data files from said first data storage device (112) to said second data storage device (128) are performed when the operation is switched from the first data processing unit (100) to the second data processing unit (120).

9. The method according to one of the preceding claims, wherein the step of selecting data files stored on said first data storage device (112) is performed by tracing system calls of said first data processing unit (100) indicating access to data stored on said data first storage device (112).

10. The method according to claim 9, wherein tracing system calls is done by using hooks, operating system features and/or shared library code.

11. A data processing apparatus comprising a first data storage device (112), a first data processing unit (100), a second data storage device (128), and a second data processing unit (120), all being arranged in a common housing, means for selecting data files stored on said first data storage device (112), and means for copying the selected data files from said first data storage device (112) to said second data storage device (128), whereby said first data storage device (112) is associated to said first data processing unit (100) and said second data storage device (128) is associated to said second data processing unit (120), and said second data processing unit (120) is configured to consume less energy than said first data processing unit (100).

12. The data processing apparatus according to claim 11, further comprising means for applying filtering rules in order to single out files to be copied.

13. The data processing apparatus acceding to claim 12, wherein said filtering rules include regular expressions.

14. The data processing apparatus according to one of the claims 11 to 13, further comprising means for choosing files being marked by a user of said first and second data processing unit (100, 120) as to be copied.

15. The data processing apparatus according to claim 14, wherein the files are being marked by using symbolic links, database entries and/or flags associated to respective files.

16. The data processing apparatus according to one of the preceding claims, further comprising means for checking the available resources on the second data processing unit (120) and, in consideration of the result, selecting data files stored on said first data storage device (112).

17. The data processing apparatus according to one of the preceding claims, further comprising means for periodically performing the steps of selecting data files stored on said first data storage device (112) and copying the selected data files from said first data storage device (112) to said second data storage device (128).

18. The data processing apparatus according to one of the claims 11 to 16, further comprising means for performing the steps of selecting data files stored on said first data storage device (112) and copying the selected data files from said first data storage device (112) to said second data storage device (128) when the operation of said apparatus is switched from the first data processing unit (100) to the second data processing unit (120).

19. The data processing apparatus according to one of the preceding claims, further comprising means for performing the step of selecting data files stored on said first data storage device (112) by tracing system calls of said first data processing unit (100) indicating access to data stored on said first storage device.

20. A computer program product stored on a computer usable medium, comprising computer readable program means for causing a computer to perform a method according to anyone of the preceding claims 1 to 10.
